(19) United States
(12) Patent Application Publication
(10) Pub. No.: US 2010/0046715 A1
(43) Pub. Date: Feb. 25, 2010

(54) X-RAY RADIATOR WITH GAS-FILLED X-RAY BEAM EXIT CHAMBER

(76) Inventor: Joerg Freudenberger, Kalchreuth (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/542,803

(22) Filed: Aug. 18, 2009

(30) Foreign Application Priority Data
Aug. 21, 2008 (DE) 10 2008 038 582.4

(51) Int. Cl. H01J 35/18; H01J 35/12

(52) U.S. Cl. 378/140; 378/141

(57) ABSTRACT

An x-ray radiator for a medical technology x-ray apparatus, has a vacuum chamber arranged in a protective housing, in which is arranged an anode that emits an x-ray beam. The vacuum chamber is surrounded by a protective chamber formed between the protective housing and the vacuum chamber and filled with an electrically insulating liquid. A beam passage chamber filled with a gas is arranged in the protective chamber. The beam passage chamber is traversed by the x-ray beam exiting from the vacuum chamber and propagating toward the protective housing. The amount of secondary radiation generated by the x-ray radiator upon operation is thereby reduced.

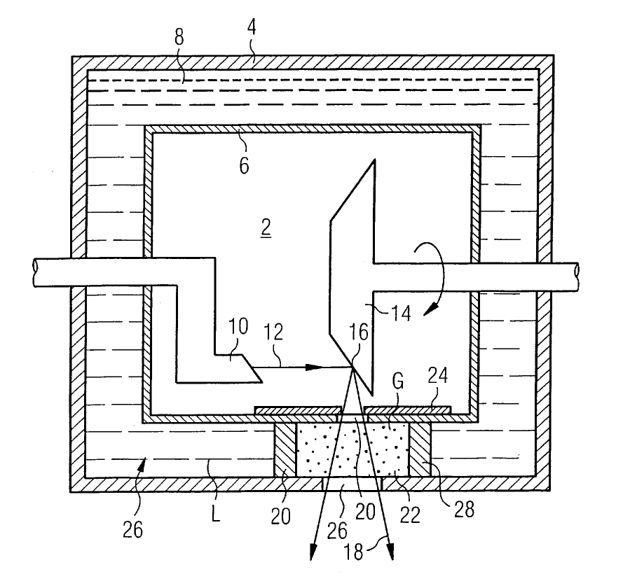

### BACKGROUND OF THE INVENTION

1. Field of the Invention

The present invention concerns an x-ray radiator of the type having a radiator housing containing an x-ray tube, wherein x-rays emitted from the anode in the x-ray tube proceed through the interior of the radiator housing and exit therefrom through a beam exit window.

2. Description of the Prior Art

An x-ray radiator is known from DE 44 30 020 C1 and DE 10 2006 024 435 A1, for example, wherein the electrons generated by a cathode are accelerated towards an anode serving as a target and there generate x-rays upon impact. The cathode and the anode are arranged in a vacuum chamber that is located in a protective housing that serves for radiation protection as well as to protect the vacuum chamber from mechanical deterioration. A protective chamber surrounding the vacuum chamber thus is formed between the vacuum chamber and the protective housing. This protective chamber is filled with a liquid (normally an oil). In addition to electrical insulation, this oil also serves to cool the vacuum chamber.

The x-ray radiation exits from the vacuum chamber, traverses the protective chamber and exits the protective housing through a beam exit window. The x-ray beam emitted from the protective housing is gated or limited to the desired degree via plate (diaphragm) arrangements arranged inside or outside the protective housing.

Particularly in medical therapy or diagnostics, the secondary or scatter radiation that unavoidably occurs in the operation of x-ray radiators due to Compton scattering represents a significant problem, since it leads to an additional dose exposure of the operator and the patient. Additionally, a degradation of the image quality also occurs due to such a secondary radiation in x-ray diagnostic devices, since the x-ray receiver (detector) additionally has x-rays incident thereto whose origin is not within the region in which the electrons from the cathode strike the anode (focal spot).

### SUMMARY OF THE INVENTION

An object of the present invention is to provide an x-ray radiator in which the occurrence of scatter radiation is reduced compared to known x-ray radiators.

The above object is achieved according to the invention by an x-ray radiator having a vacuum chamber arranged in a protective housing in which is arranged an anode that emits an x-ray beam. The vacuum chamber is surrounded by a protective chamber formed between the protective housing and the vacuum chamber, that is filled with an electrically insulating liquid. The x-ray beam escaping from the vacuum chamber and propagating toward the protective housing traverses a beam passage chamber arranged in the protective chamber and filled with a gas.

The invention is based on the insight that, in known x-ray radiators, a portion of the secondary radiation arises when the x-ray beam escaping from the vacuum chamber traverses the liquid used in the protective chamber for cooling and/or insulation. The x-rays are already scattered in the protective chamber by the electrons of the liquid molecules, due to the Compton effect. With sufficient electrical insulation, the magnitude of the secondary x-rays generated by the primary x-rays in the region between vacuum chamber and protective housing can accordingly be reduced forming at least a portion of the path traversed by the x-rays within the protective chamber as a medium that has a lower density than the oil normally used as an insulation liquid. This is achieved according to the invention by a beam passage chamber arranged in the beam path of the x-ray beam in the protective chamber and filled with gas.

The beam passage chamber advantageously extends from the vacuum chamber to the protective housing and in this way occupies all of the intervening space between the vacuum chamber and the protective housing in the region traversed by the x-rays. It is separated in a fluid-sealed manner from an adjoining region of the protective chamber, that is filled with electrically insulating liquid by one or more electrically insulating side walls extending from the vacuum chamber to the protective housing. The x-rays escaping from the vacuum chamber through a first x-ray exit window thereby travel the entire distance inside the housing within the protective chamber up to a second beam exit window arranged in the protective housing, such that the degree of scatter radiation is minimal.

Dry air, nitrogen, advantageously sulfur hexafluoride SF₆ are suitable as a gas in this beam passage chamber, and the pressure in the beam passage chamber is advantageously greater than 1 bar.

The first x-ray exit window can be provides with a beam gating a diaphragm, in particular a diaphragm containing tungsten as an absorber, so the solid angle of the x-ray beam escaping from the vacuum chamber is limited to the desired degree even before the entrance into the beam passage chamber filled with the gas, and the secondary radiation generated by the x-rays within the protective housing is further reduced.

### BRIEF DESCRIPTION OF THE DRAWING

The single FIGURE schematically illustrates an x-ray radiator according to the invention in section.

### DESCRIPTION OF THE PREFERRED EMBODIMENTS

According to the FIGURE, the x-ray radiator has a vacuum chamber 2 that is arranged in a protective housing 4 so that a protective chamber 8, surrounding the vacuum chamber 2 and bounded by its wall 6 as well as the protective housing 4, is formed between the vacuum chamber 2 and the protective housing 4. An electron beam 12 emitted from a cathode 10 is focused on an anode 14 (a rotating anode in this example) and there generates an x-ray beam 18 emanating from a focal spot 16. The x-ray beam 18 exits through a first beam exit window 20 (for example a thin aluminum, beryllium or titanium foil) located in the wall 6 of the vacuum chamber 2 and proceeds into a beam passage chamber 22 arranged in the beam path of the x-ray beam 18 within the protective chamber 8 between the vacuum chamber 2 and the protective housing 4, and filled with a gas G.

Dry air, nitrogen, in particular sulfur hexafluoride SF₆ are suitable as the gas G that, like the oils that are typically used, exhibits advantageous electrical insulation properties at a pressure of approximately 3 bar. A diaphragm 24 that contains tungsten W as an absorber is arranged on the inside of the wall 6 of the vacuum chamber 2 for beam limitation.

The dimensions of the beam passage chamber 22 are matched to the x-ray beam 18 at its (maximum) diameter transverse to the propagation direction of the x-ray beam 18 and exceed this diameter only slightly. The region of the protective chamber 8 located outside of the beam passage chamber 22 is filled with an electrically insulating liquid L.

The x-ray beam 18 traverses the beam passage chamber 22 and exits from the protective housing 4 through a second beam exit window 26 arranged in the protective housing 4.

In the exemplary embodiment shown in the FIGURE, the beam passage chamber 22 extends from the vacuum chamber 2 to the protective housing 4 so that the x-ray beam 18 is bounded in the propagation direction of the x-ray beam 18 as viewed from the wall 6 of the vacuum chamber 2 and the protective housing 4. Depending on its geometric shape (for example cylindrical or cuboid), it is separated in a fluid-sealed manner from the adjoining region of the protective chamber 4 filled with the electrically insulating fluid L by one or more electrically insulating side walls 28 extending from the vacuum chamber 2 to the protective housing 4. The side walls 28 are formed of an electrically insulating material in order to electrically insulate the wall 6 of the vacuum chamber 2 (which normally is at a high voltage potential) from the protective housing 4. Since the beam passage chamber filled with the gas G extends from the first beam exit window 20 to the second beam exit window 26, the magnitude of the secondary x-ray radiation arising due to Compton scattering within the protective chamber 8 is significantly reduced.

Although modifications and changes may be suggested by those skilled in the art, it is the intention of the inventor to embody within the patent warranted hereon all changes and modifications as reasonably and properly come within the scope of his or her contribution to the art.

I claim as my invention:

1. An x-ray radiator comprising:
a vacuum chamber containing an anode from which an x-ray beam is emitted;
a radiator housing having an interior in which said vacuum chamber is disposed;
a protective chamber formed between said radiator housing and said vacuum chamber, said protective chamber being filled with an electrically insulating liquid;
a beam exit window in said radiator housing through which said x-ray beam exists said radiator housing; and
a beam passage chamber located in said protective housing between said vacuum chamber and said beam exit window, through which said x-ray beam propagates from said vacuum housing to said beam exit window, said beam passage chamber being filled with a gas.

2. An x-ray radiator as claimed in claim 1 wherein said beam passage chamber comprises a plurality of electrically insulating side walls extending from said vacuum chamber to a wall of said radiator housing in which said beam exit window is disposed, said electrically insulating side walls being configured to provide fluid-sealed separation between an interior of the beam passage chamber and the insulating liquid in said protective housing.

3. An x-ray radiator as claimed in claim 1 wherein said gas is sulfur-hexafluoride.

4. An x-ray radiator as claimed in claim 1 comprising a beam-gating diaphragm arrangement located at said beam exit window.

5. An x-ray radiator as claimed in claim 1 wherein said vacuum chamber comprises interior walls having dimensions that permit passage of said x-ray beam through said vacuum chamber without said x-ray beam striking said interior walls.

6. An x-ray radiator as claimed in claim 5 wherein said x-ray beam comprises beam dimensions, and wherein said dimensions of said interior walls of said vacuum chamber minimally exceed said beam dimensions to permit unimpeded passage of said x-ray beam through said beam passage chamber.
